(19) United States
(12) Patent Application Publication
(10) Pub. No.: US 2019/0032313 A1
(43) Pub. Date: Jan. 31, 2019

(54) Clip Assembly For Securing A Sink To A Countertop

(71) Applicant: David Pottle, Las Vegas, NV (US)

(72) Inventor: David Pottle, Las Vegas, NV (US)

(21) Appl. No.: 16/050,020

(22) Filed: Jul. 31, 2018

Related U.S. Application Data
(60) Provisional application No. 62/538,871, filed on Jul. 31, 2017.

(51) Int. Cl. E03C 1/33; F16B 2/06

(52) U.S. Cl. CPC E03C 1/33; F16B 2/06

(57) ABSTRACT

A clip assembly for securing a sink to an opening in a countertop is disclosed. The clip assembly comprises a clip portion comprising a first portion having an opening, and a second portion spaced from the first portion. The second portion has a thruway, and the thruway includes a pawl. The clip assembly further includes a fastener portion comprising a head portion and a tape portion extending from the head portion. The tape portion includes a gear rack extending along a length of the tape portion. The tape portion is adapted for insertion through the opening of the first portion and the thruway of the second portion, such that the gear rack of the tape portion cooperatively engages the pawl.

### FIELD OF THE INVENTION

The present invention relates to an improved clip for securing a sink, such as a kitchen or bathroom sink, to a supporting platform, such as a countertop.

### BACKGROUND OF THE INVENTION

Mounting clips, such as for securing a sink within an opening in a countertop, are known. See for example Brown, U.S. Pat. No. 7,185,376.

Brown describes a prior art sink clip at column 1, beginning at line 11, in conjunction with FIG. 1, thereof. Specifically Brown describes a mounting clip 14 disposed within a channel 22 in a lip portion 24 of a sink 10. The mounting clip 14 includes a threaded fastener 16 having a head portion 18 and a countertop engaging portion 20. The head portion 18 is generally sized to fit within the channel 22 disposed upon the lip portion 24 of the sink 10. To mount the sink 10 to the countertop 12, the user/installer first places the sink 10 within an opening 26 in the countertop 12. Next the user inserts the head portion 18 of one or more clips 14 within the channel 22. The countertop engagement section portion 20 includes a tip portion 28, which engages the bottom surface 30 of the countertop 12. To secure the sink 10 to the countertop 12, the user must then rotate the threaded aperture 16 until the countertop engagement portion 28 and in particular the tip 28 is tight and the sink 10 is secure.

In a different embodiment, Brown discloses a mounting device, or clip, 40 for securing a sink 10 within an opening 26 of a countertop 26. The clip 40 may include a body 42 including a channel engaging section 48 and a flexible sink engagement portion 44. The clip 40 may also include a threaded fastener 46, extending through first and second apertures 52, 54. The user must rotate the fastener 46, to draw the flexible sink engagement portion 44 towards the channel engaging section 48. As further disclosed in Brown, a tip 68 of the flexible sink engagement portion 44 may engage sides 78 of the countertop 12, to secure the sink 10 in the opening 26.

However in either case, installation requires the user/installer to rotate the threaded fastener relative to the clip, or rotate a threaded nut relative to the threaded fastener. This can often be difficult, particularly when working in a cabinet below the sink.

The present invention is provided to solve these and other problems.

### SUMMARY

In accordance with the present disclosure, a mounting clip assembly is provided which utilizes a tie strap system including a tie strap comprising a flexible tape having an integrated gear rack, and a cooperating ratchet to draw opposing projections of a sink clip together, to secure a sink within an opening of a countertop.

Other features and advantages of the present invention should become apparent from the following description of the preferred embodiment, taken in conjunction with the accompanying drawings, which illustrate, by way of example, principles of the invention.

### DESCRIPTION OF THE FIGURES

For a more complete understanding of the disclosure, reference should be made to the following detailed description and accompanying drawings, wherein:

FIG. 1 illustrates a clip assembly, such as for securing a sink to a countertop, in accordance with the present invention;

FIG. 2 illustrates a generally u-shaped clip portion of the clip assembly of FIG. 1;

FIG. 3 is a sectional view of the clip portion of FIG. 2;

FIG. 4 is a generally upper view of the clip portion of FIG. 2;

FIG. 5 is a generally lower view of the clip portion of FIG. 2;

FIG. 6 illustrates a fastener of the clip assembly of FIG. 1;

FIG. 7 is a partial view of the fastener of FIG. 6;

FIG. 8 is a partial view of the fastener of FIG. 6;

FIG. 9 is a sectional view of the fastener of FIG. 6; and

FIGS. 10-11 illustrate the mounting clip assembly of FIGS. 1-9 cooperating with a sink basin to retain the sink basin within a countertop opening.

### DESCRIPTION OF THE PREFERRED EMBODIMENT

While this invention is susceptible of embodiment in many different forms, there will be described herein in detail, a specific embodiment thereof with the understanding that the present disclosure is to be considered an exemplification of the principles of the invention and is not intended to limit the invention to the specific embodiment illustrated.

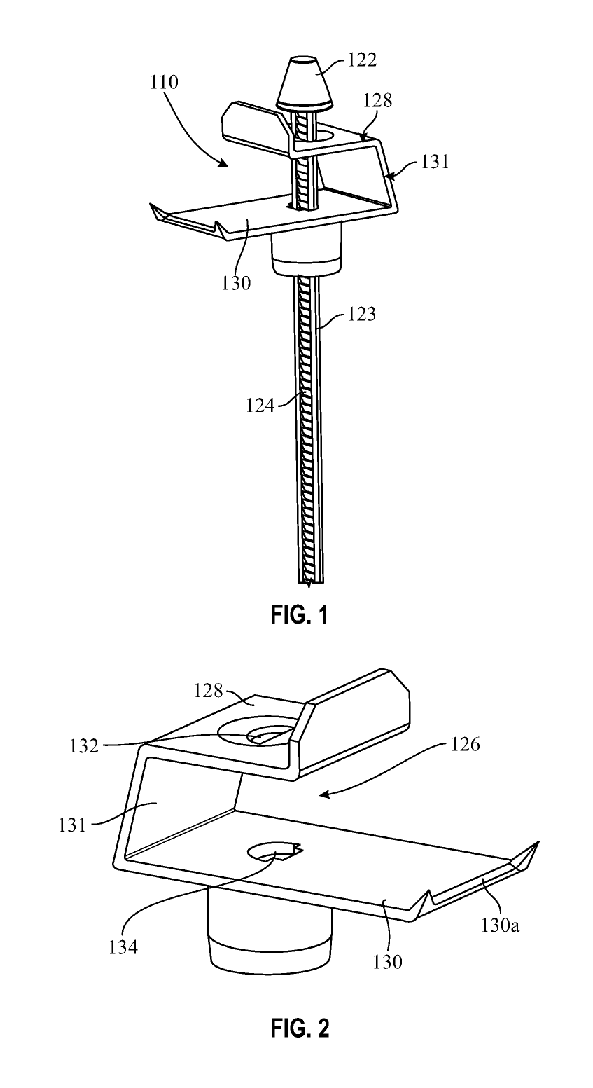

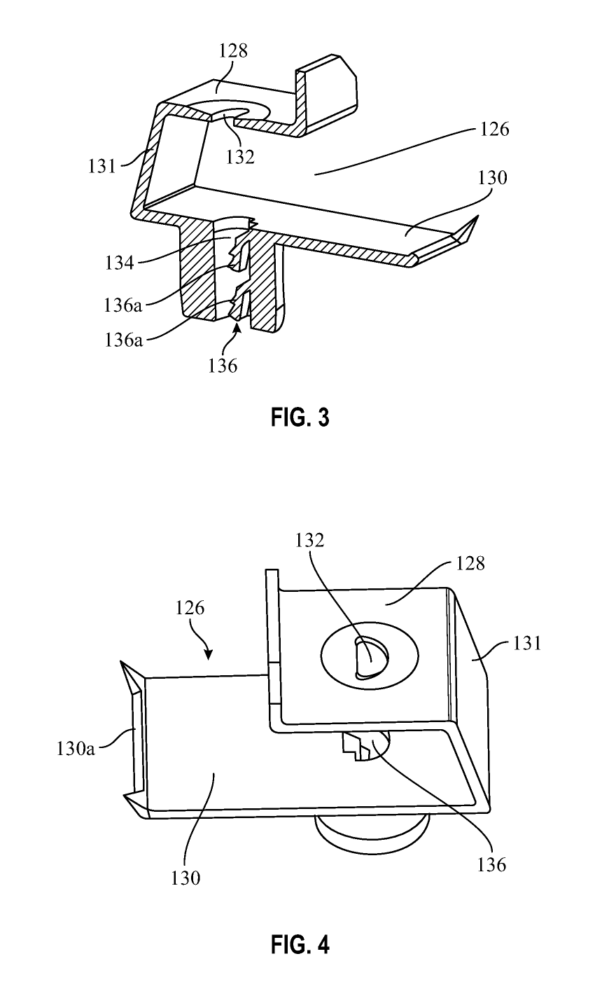

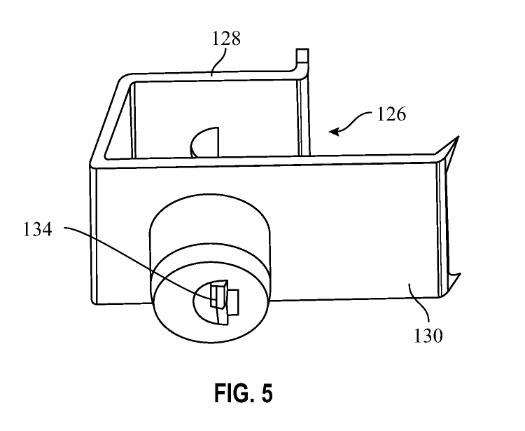

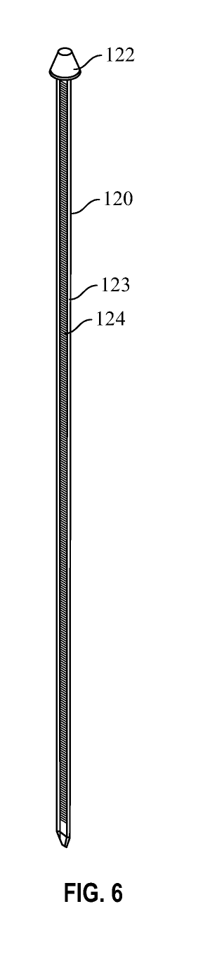

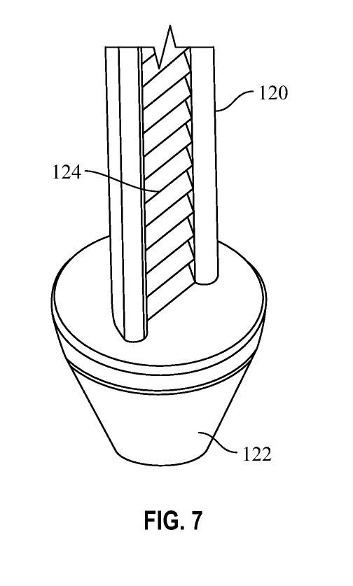

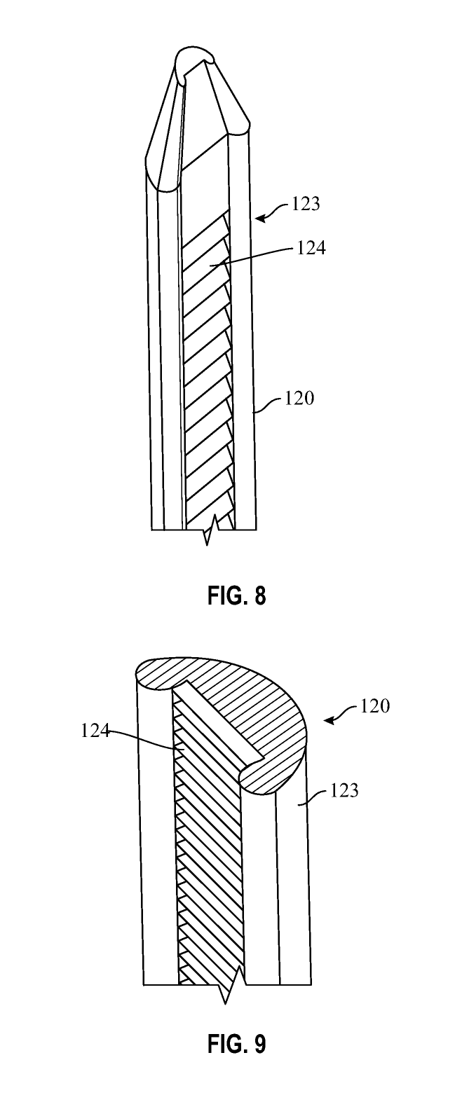

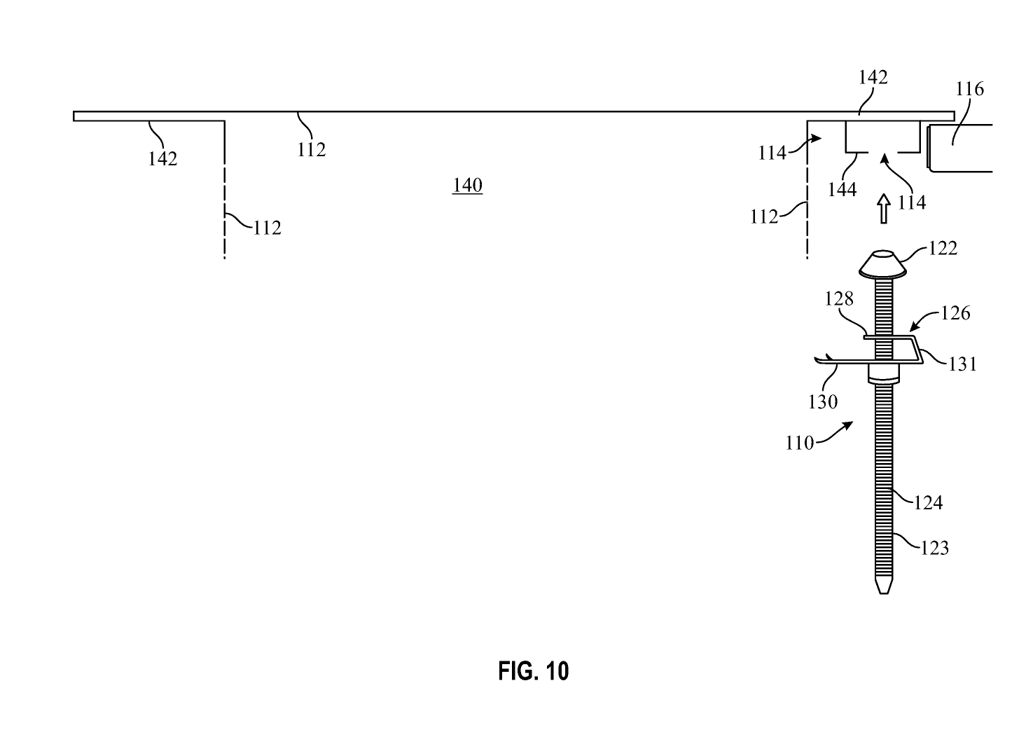

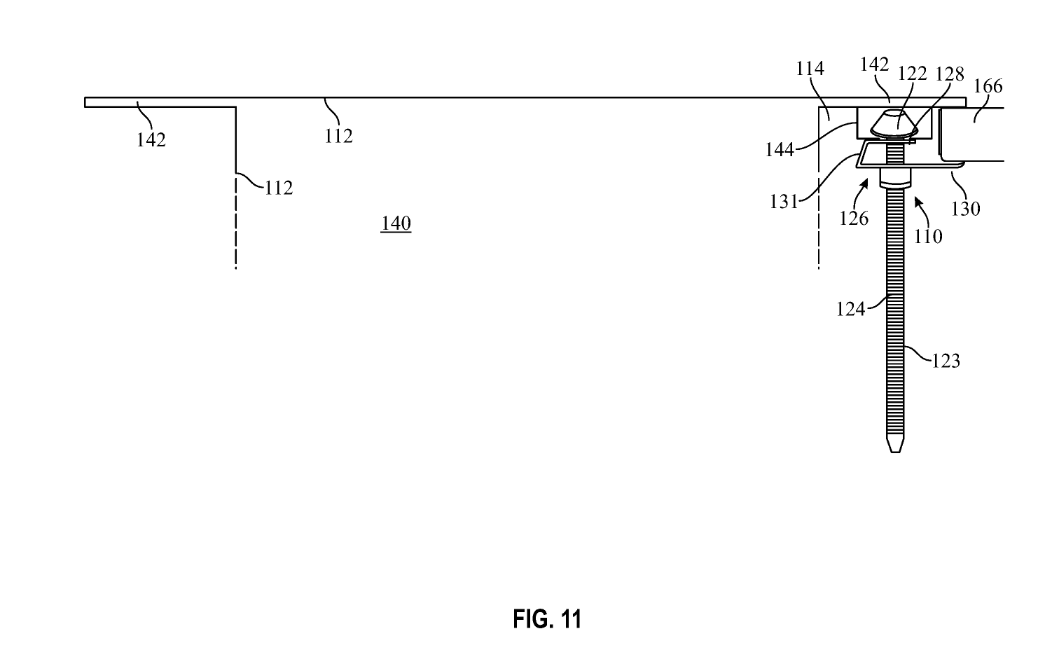

In accordance with the present invention, a mounting clip assembly 110 is illustrated in FIGS. 1-9. As illustrated in FIGS. 10-11, the mounting clip assembly 110 may be used for mounting a sink 112, such as a conventional kitchen or bathroom sink, in an opening 114 of a platform, such as a countertop, 116.

Referring to FIGS. 1-9, the clip assembly 110 may include a fastener 120 having a head portion 122 disposed at one end thereof. The fastener 120 may further include a generally flat, in cross-section, tape portion 123, which may be flexible or rigid, extending from the head portion 122. The tape portion 123 may include a gear rack 124 extending generally along a length of the tape portion 123. The fastener 120 may be similar to a cable tie, and may be made of nylon, stainless steel, or the like.

The clip assembly 110 may further include a generally u-shaped clip portion 126 having a first portion 128, a second portion 130 spaced from the first portion 128, and a coupling portion 131, which may be flexible, coupling the first portion 128 to the second portion 130.

The first portion 128 may include an opening 132, which may be slotted. The second portion 130 may include a thruway 134 proximal the coupling portion and axially spaced from the opening 132. The thruway 134 may include a pawl 136, which may include one or more ratcheted teeth 136a. As discussed below, the pawl 136 of the clip portion 126 may be adapted to cooperatively engage the gear rack 124 of the fastener 120. The second portion 130 may include a conventional clip lip 130a for engaging an underside of the countertop 116, as discussed below.

Referring now to FIGS. 10 and 11, the sink 112 is illustrated disposed within the opening 114 of the platform/countertop 116. The sink 112 may include a sink basin 140, and a conventional sink flange, or lip, 142 extending about the periphery of the sink basin 140. The sink 112 may further include one or more conventional retaining channels 144, which may be disposed about the underside of the sink 112, such as about the underside of the sink flange 142.

According to one embodiment of the present invention, to securely mount the sink 112 within the opening 114 of the countertop 116, the tape portion 123 may be threaded through the opening 132 and through the thruway 134. The head portion 122 of the fastener 120 may then be inserted into the sink flange 140, and the second portion 130 of the clip portion 126 may be positioned below the underside of the countertop 116. The tape portion 123 may then be pulled downwardly, in a direction away from the head portion 122. As the tape portion 123 is pulled away from the head portion 122, the head portion 122 may be pulled into engagement with the retaining channel 144. The tape portion 123 may be pulled further downwardly, while upwardly (towards the sink flange 142) pushing the clip portion 126, drawing the sink 112 into a secure engagement with the countertop 116. The pawl 136 may engage the gear rack 124 relative to the clip portion 126, preventing the clip portion 126 from releasing the gear rack 124, thus preventing the clip portion 126 from releasing the fastener 120. Any excess material of the tape portion 123 may be cut, as desired.

It is to be understood that this disclosure is not intended to limit the invention to any particular form described, but to the contrary, the invention is intended to include all modifications, alternatives and equivalents falling within the spirit and scope of the invention.

We claim:

1. A clip assembly for securing a sink to an opening in a countertop, the clip assembly comprising:
a clip portion comprising a first portion having an opening, and a second portion spaced from the first portion, the second portion having a thruway, wherein the thruway includes a pawl; and
a fastener portion comprising a head portion and a tape portion extending from the head portion, wherein the tape portion includes a gear rack extending along a length of the tape portion;
wherein the tape portion is adapted for insertion through the opening of the first portion and the thruway of the second portion, such that the gear rack of the tape portion cooperatively engages the pawl.

2. The clip assembly of claim 1, wherein the tape portion is flexible.

3. The clip assembly of claim 2, wherein the tape portion is formed of nylon.

4. The clip assembly of claim 1, wherein the pawl includes a plurality of teeth.

5. The clip assembly of claim 1 including a coupling portion coupling the first portion to the second portion.

6. The clip assembly of claim 5, wherein the coupling portion is flexible, to flexibly couple the first portion to the second portion.

7. The clip assembly of claim 1, wherein the head portion is adapted to engage the sink and the second portion is adapted to engage the countertop.

8. The clip assembly of claim 1, wherein the clip portion is generally u-shaped.

9. A method of securing a sink in an opening of a countertop, the sink including a sink flange having a distal portion adapted to engage the countertop about the periphery of the opening, and a sink channel on an underside of the sink flange, the method comprising:
positioning the sink in the opening of the countertop such that the sink flange is resting on the countertop;
providing a clip assembly, the clip assembly comprising a generally clip portion and a fastener portion, wherein the clip portion comprises a first portion, a second portion spaced from the first portion, and a coupling portion coupling the first portion to the second portion, wherein the first portion has an opening, and the second portion has a thruway proximate the coupling portion, the thruway including a pawl, and the second portion further including a clip lip distal the coupling portion, and wherein the fastener portion comprises a head portion and a tape portion extending from the head portion, and wherein the tape portion includes a gear rack extending along a length of the tape portion;
inserting the head portion in the sink channel;
inserting the tape portion through the opening of the first portion and through the thruway of the second portion, such that the gear rack of the tape portion cooperatively engages the pawl;
pushing the second portion upwards into secure engagement of the clip lip with the underside of the countertop, while drawing down the head into engagement with the sink channel.
